(19) United States
(12) Patent Application Publication
(10) Pub. No.: US 2026/0021015 A1
(43) Pub. Date: Jan. 22, 2026

(54) HEADBAND DEVICE FOR STIMULATING HAIR GROWTH

(71) Applicant: Shenzhen Kaiyan Medical Equipment Co., Ltd., Shenzhen (CN)

(72) Inventors: Alain Dijkstra, Amstelveen (NL); LI XIANG, Shenzhen (CN); Hu Chunlei, Shenzhen (CN); Yan Yuansong, Shenzhen (CN)

(73) Assignee: Shenzhen Kaiyan Medical Equipment Co., Ltd., Shenzhen (CN)

(21) Appl. No.: 18/931,114

(22) Filed: Oct. 30, 2024

(30) Foreign Application Priority Data
Jul. 17, 2024 (CN) 202421703256.4

(51) Int. Cl. A61H 15/00; A61H 15/02

(52) U.S. Cl. CPC A61H 15/0085; A61H 15/02; A61H 2015/0028; A61H 2201/0107; A61H 2201/0153; A61H 2201/0157; A61H 2201/0207; A61H 2201/0214; A61H 2201/105; A61H 2201/1215; A61H 2201/1607; A61H 2201/165; A61H 2201/1671; A61H 2201/5007; A61H 2205/021

(57) ABSTRACT

Embodiments of the present invention provide a headband device for stimulating hair growth. The device comprising one or more comb tooth piece configured to detachably connect with an inner surface of the headband body; at least one stimulation element on the inner surface of the headband body; one or more massage head on the inner surface of the headband body; and a driving assembly connected to the one or more massage head, the driving assembly is configured to rotate the massage head. The headband body has a first magnetic piece and the one or more comb tooth piece has a second magnetic piece that detachably attached to the first magnetic piece.

### TECHNICAL FIELD

The present invention generally relates to a therapeutic devices and, more particularly, to a headband device that stimulates hair growth.

### BACKGROUND ART

In this era of rapid development, hair loss is not only a physical problem but also an unspeakable pain in the hearts of many people. Especially in today's prevalence of social media, people are paying more and more attention to their appearance, and the problem of hair loss has become a shadow in many people's hearts.

In addition to common genetic factors, hair loss may also be closely related to our lifestyle habits, dietary habits, and environmental factors. For example, long-term mental stress and high-intensity work rhythm may make our scalp in a state of tension for a long time, which can affect the health of hair follicles. In addition, poor dietary habits, such as deficiencies in key nutrients such as protein, vitamins and minerals, can also lead to brittle hair and even fall out.

There are two main forms of hair loss treatment, the first is internal drug treatment, which includes internal and external medications, but there are problems with long treatment courses, high costs, and possible side effects. The second is external treatments, such as scalp massage, acupuncture, laser treatment, etc., which may be effective for some people, but their results vary from person to person and often require long-term persistence to see significant improvements.

The hair growth headband of the current market generally comprises the headband body and the comb belt that is arranged on the inner side of the headband body. When the headband is used for a long time, the comb tooth band is easy to produce dirt, breeds bacteria. In the existing hair growth headband, the comb tooth band is fixedly connected with the headband body, which is not conducive to the replacement and cleaning of the comb tooth band, and has affected the comfort and safety of the hair growth headband.

### OBJECTS OF THE INVENTION

Some of the objects of the invention are as follows:

An object of the present invention is to provide a headband device with a detachable comb tooth piece to facilitate replacement and cleaning of the comb tooth piece.

Another object of the present invention is to provide a headband device with a plurality of massage head to massage the scalp skin.

Another object of the present invention is to provide a headband device having one or more stimulation elements to promote hair growth.

Another object of the present invention is to provide a headband device with a driving assembly to drive the rotation of the plurality of massage head.

Another object of the present invention is to provide a headband device with an elastic connecting portion so as to enable the hairband device to fir over head of any size.

Another object of the present invention is to provide a headband device with magnetic suction piece to facilitate easy detachment of the comb tooth pieces.

Another object of the present invention is to provide a headband device with a plurality of strip-shaped grooves to accommodate the comb tooth pieces.

### SUMMARY OF THE INVENTION

According to a first aspect of the present invention, a device for stimulating hair growth is provided. The device comprising: a main body portion; one or more comb tooth piece configured to detachably connect with an inner surface of the main body portion; at least one stimulation element on the inner surface of the main body portion; one or more massage head on the inner surface of the main body portion; and a driving assembly connected to the one or more massage head, the driving assembly is configured to rotate the massage head.

In one embodiment of the invention, the device further comprises: a first clamping portion, a first end of the first clamping portion is connected with a first end of the main body portion; and a second clamping portion, a first end of the second clamping portion is connected with a second end of the main body portion.

In one embodiment of the invention, the device further comprises: a first elastic connecting portion, a first end of the first elastic connecting portion is connected with the first clamping portion, and a second end of the first elastic connecting portion is connected with the main body portion; and a second elastic connecting portion, a first end of the second elastic connecting portion is connected with the second clamping portion, and a second end of the second elastic connecting portion is connected with the main body portion.

In one embodiment of the invention, the one or more comb tooth pieces are arranged on an inner edge of the main body portion, the first clamping portion and the second clamping portion.

In one embodiment of the invention, the one or more comb tooth piece comprises a connecting plate, the connecting plate has a plurality of comb teeth arranged along the length direction of the connecting plate.

In one embodiment of the invention, the inner surface of the device comprises a strip-shaped grooves, and the connecting plate is clamped into the strip-shaped grooves.

In one embodiment of the invention, the at least one stimulation element is selected from a group consisting of Light Emitting Diodes (LEDs), lasers, heating elements, cooling elements, vibration elements, electrodes, micro-current element and combinations thereof.

In one embodiment of the invention, the light-emitting assembly comprises: a light source in the device; and a light transmission plate, the inner surface of the device is provided with an opening, the light transmission plate is connected with the device at the opening, and the light emitted by the light source is emitted through the light transmission plate.

In one embodiment of the invention, the driving assembly comprises: a driving member; an input gear connected with an output end of the driving member; an output gear connected with the input gear; and a transmission shaft rotatably connected with the main body portion, and the output gear and the one or more massage head are connected to the transmission shaft.

In one embodiment of the invention, the output end is a worm, the input gear comprises a worm gear and a transmission gear, the worm is meshed with the worm gear, and the transmission gear is meshed with the output gear.

In one embodiment of the invention, the device comprises a plurality of massage head and each of the plurality of massage head is connected to the driving assembly.

In one embodiment of the invention, the device has a first magnetic piece and the one or more comb tooth piece has a second magnetic piece that detachably attached to the first magnetic piece.

According to a second aspect of the present invention, a device for stimulating hair growth is provided. The device comprising: two or more clamping portion, wherein at least one of the two or more clamping portion comprises: one or more comb tooth piece configured to detachably connect with the clamping portion; at least one stimulation element on the inner surface of the clamping portion; one or more massage head on the inner surface of the clamping portion; and a driving assembly connected to the one or massage head, the driving assembly is configured to rotate the massage head.

In one embodiment of the invention, the driving assembly rotates the one or more massage head in clockwise or anticlockwise direction.

In one embodiment of the invention, the one or more massage head comprises a first row of plurality of massage head and a second row of plurality of massage head.

In one embodiment of the invention, the driving assembly rotates the first row of plurality of massage head in clockwise direction and second row of plurality of massage head in anticlockwise direction.

In one embodiment of the invention, the two or more clamping portion has a first magnetic piece and the one or more comb tooth piece has a second magnetic piece that detachably attached to the first magnetic piece.

In one embodiment of the invention, the device further comprises a controlling unit positioned at two or more clamping portion or at one of the two or more clamping portion, the controlling unit is configured to independently control the functioning of the two or more clamping portion.

In one embodiment of the invention, the two or more clamping portion are connected with each other through an elastic connecting portion.

In one embodiment of the invention, the one or more comb tooth piece are hollow and are used for dispensing a medicament or a lotion.

According to a third aspect of the present invention, a device for stimulating hair growth is provided. The device comprising: a main body portion; one or more comb tooth piece configured to detachably connect with an inner surface of the main body portion; at least one stimulation element on the inner surface of the headband body; one or more massage head on the inner surface of the main body portion; and a driving assembly connected to the one or more massage head, the driving assembly is configured to rotate the massage head; wherein the device has a first magnetic piece and the one or more comb tooth piece has a second magnetic piece that detachably attached to the first magnetic piece.

In the context of the specification, the term “processor” refers to one or more of a microprocessor, a microcontroller, a general-purpose processor, a Field Programmable Gate Array (FPGA) or an Application Specific Integrated Circuit (ASIC), and the like.

In the context of the specification, the phrase “memory unit” refers to volatile storage memory, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc.

In the context of the specification, the phrase “storage device” refers to a non-volatile storage memory such as EPROM, EEPROM, flash memory, or the like.

In the context of the specification, the phrase “communication interface” refers to a device or a module enabling direct connectivity via wires and connectors such as USB, HDMI, VGA, or wireless connectivity such as Bluetooth or Wi-Fi, or Local Area Network (LAN) or Wide Area Network (WAN) implemented through TCP/IP, IEEE 802.x, GSM, CDMA, LTE, or other equivalent protocols.

In the context of the specification, the phrase “communication network” refers to a group of several connected devices including computing devices (such as desktops, mobile handheld devices, tablet PCs, notebooks, etc.), local and remotely located servers (such as web servers, application servers, database servers, Application Program Interface (API) servers, load balancers, compute nodes, and the like), routers, antennas, modems, multiplexers, demultiplexers, and the like. In that regard, the aforementioned connected devices may be able to exchange data signals through wired and/or wireless means as per several combinations of several different communication protocols such as 802.11 (Wi-Fi), 802.3 (Ethernet), Bluetooth, NFC, ZigBee and 3GPP protocols such as HSPA, HSDPA, LTE, GSM, CDMA, WLL and the like.

In the context of this specification, terms like “light”, “radiation”, “irradiation”, “emission” and “illumination”, etc. refer to electromagnetic radiation in frequency ranges varying from the Ultraviolet (UV) frequencies to Infrared (IR) frequencies and wavelengths, wherein the range is inclusive of visible light, UV and IR frequencies and wavelengths. It is to be noted here that UV radiation can be categorized in several manners depending on respective wavelength ranges, all of which are envisaged to be under the scope of this invention. For example, UV radiation can be categorized as, Hydrogen Lyman-α (122-121 nm), Far UV (200-122 nm), Middle UV (300-200 nm), and Near UV (400-300 nm). The UV radiation may also be categorized as UVA (400-315 nm), UVB (315-280 nm), and UVC (280-100 nm) Similarly, IR radiation may also be categorized into several categories according to respective wavelength ranges which are again envisaged to be within the scope of this invention. A commonly used subdivision scheme for IR radiation includes Near IR (0.75-1.4 μm), Short-Wavelength IR (1.4-3 μm), Mid-Wavelength IR (3-8 μm), Long-Wavelength IR (8-15 μm) and Far IR (15-1000 μm).

In the context of the specification, when an element is referred to as being “fixed to” or “disposed to” another element, it may either directly on another element or indirectly on that other element. When a component is said to be “connected” or “connected to” another component, it may be directly connected to another component or indirectly connected to other component on the piece.

In the context of the specification, the terms “first’, “second” and “third” are only used for descriptive purpose and does not implicate the relative importance or to implicitly indicate the quantity of technical features indicated.

In the context of the specification, the term “plurality” means two or more than two, unless otherwise indicated.

In the context of the specification, the term “several” means more than one, unless otherwise specified.

In the context of the specification, “Light Emitting Diodes (LEDs)” refer to semiconductor diodes capable of emitting electromagnetic radiation when supplied with an electric current. The LEDs are characterized by their superior power efficiencies, smaller sizes, rapidity in switching, physical robustness, and longevity when compared with incandescent or fluorescent lamps. In that regard, the one or more LEDs may be through-hole type LEDs (generally used to produce electromagnetic radiations of red, green, yellow, blue and white colors), Surface Mount Technology (SMT) LEDs, Bi-color LEDs, Pulse Width Modulated RGB (Red-Green-Blue) LEDs, and high-power LEDs, etc.

Materials used in the one or more LEDs may vary from one embodiment to another depending upon the frequency of radiation required. Different frequencies can be obtained from LEDs made from pure or doped semiconductor materials. Commonly used semiconductor materials include nitrides of Silicon, Gallium, Aluminum, and Boron, and Zinc Selenide, etc. in pure form or doped with elements such as Aluminum and Indium, etc. For example, red and amber colors are produced from Aluminum Indium Gallium Phosphide (AlGaInP) based compositions, while blue, green, and cyan use Indium Gallium Nitride based compositions. White light may be produced by mixing red, green, and blue lights in equal proportions, while varying proportions may be used for generating a wider color gamut. White and other colored lightings may also be produced using phosphor coatings such as Yttrium Aluminum Garnet (YAG) in combination with a blue LED to generate white light and Magnesium doped potassium fluorosilicate in combination with blue LED to generate red light. Additionally, near Ultraviolet (UV) LEDs may be combined with europium-based phosphors to generate red and blue lights and copper and zinc doped zinc sulfide-based phosphor to generate green light.

In addition to conventional mineral-based LEDs, one or more LEDs may also be provided on an Organic LED (OLED) based flexible panel or an inorganic LED-based flexible panel. Such OLED panels may be generated by depositing organic semiconducting materials over Thin Film Transistor (TFT) based substrates. Further, discussion on generation of OLED panels can be found in Bardsley, J. N (2004), “International OLED Technology Roadmap”, IEEE Journal of Selected Topics in Quantum Electronics, Vol. 10, No. 1, that is included herein in its entirety, by reference. An exemplary description of flexible inorganic light-emitting diode strips can be found in granted U.S. Pat. No. 7,476,557 B2, titled “Roll-to-roll fabricated light sheet and encapsulated semiconductor circuit devices”, which is included herein in its entirety, by reference.

In several embodiments, the one or more LEDs may also be micro-LEDs described through U.S. Pat. Nos. 8,809,126 B2, 8,846,457 B2, 8,852,467 B2, 8,415,879 B2, 8,877,101 B2, 9,018,833 B2 and their respective family members, assigned to NthDegree Technologies Worldwide Inc., which are included herein by reference, in their entirety. The one or more LEDs, in that regard, may be provided as a printable composition of the micro-LEDs, printed on a substrate.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1 shows a perspective view of a headband device for stimulating hair growth in accordance with an embodiment of the present invention.

FIG. 2 shows a bottom perspective view of a headband device for stimulating hair growth in accordance with an embodiment of the present invention.

FIG. 3 shows a perspective view of a headband device showing one or more stimulation element for stimulating hair growth in accordance with an embodiment of the present invention.

FIG. 4 shows a three-dimensional structure of the comb tooth piece in the headband device in accordance with an embodiment of the present invention.

FIG. 5 shows a massage head present in the headband device in accordance with an embodiment of the present invention.

FIG. 6 shows a driving assembly in the headband device for driving the massage head in accordance with an embodiment of the present invention.

FIG. 7 shows the layout of the headband device in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

The terms “a” and “an” herein do not denote a limitation of quantity, but rather denote the presence of at least one of the referenced items. The terms “having”, “comprising”, “including”, and variations thereof signify the presence of a component.

Embodiments of the present invention disclose a headband device. The headband device comprises a headband body, a comb tooth piece, at least one stimulation element, a massage head and a driving assembly. The headband body comprises of two or more clamping portion along with a main body portion, or the two or more clamping portion includes the main body portion. Each of the clamping portion may comprise a massage head, comb tooth piece and one or more stimulation element. The comb tooth piece is detachably attached to the inner side of the headband body. The at least one stimulation element is mounted on the headband body and is used to emit light to the inside of the headband body. The massage head can be rotated to connect to the inner surface of the headband body. The driving assembly is installed in the headband body and is connected to the massage head. The comb tooth piece is detachably connected with the headband body, and different types of comb parts can be selected according to different people, and the cleaning of the comb parts is also convenient, and the comfort and safety of the hair growth headband wearing are improved.

Several additional functionalities may also be added to the therapeutic device. For example, the head band body is provided with a first magnetic piece and the comb tooth piece has a second magnetic piece. The second magnetic piece magnetically bind with the first magnetic piece to detachably fix the comb tooth piece on the headband body. The each of the clamping portion can be controlled independently by a controlling unit. The controlling unit is configured to activate the massage head and controlling the intensity and wavelength of the stimulation element, such that one clamping portion has different components activated than the other clamping portion. The device can also be controlled by a user computing device communicating with the apparatus over a communication network through a communication interface built into the therapeutic device.

The at least one stimulation element is selected from a group consisting of Light Emitting Diodes (LEDs), lasers, heating elements, cooling elements, vibration elements, electrodes, and combinations thereof. This enables the multi-functional bottle to provide a wide range of alternate therapies.

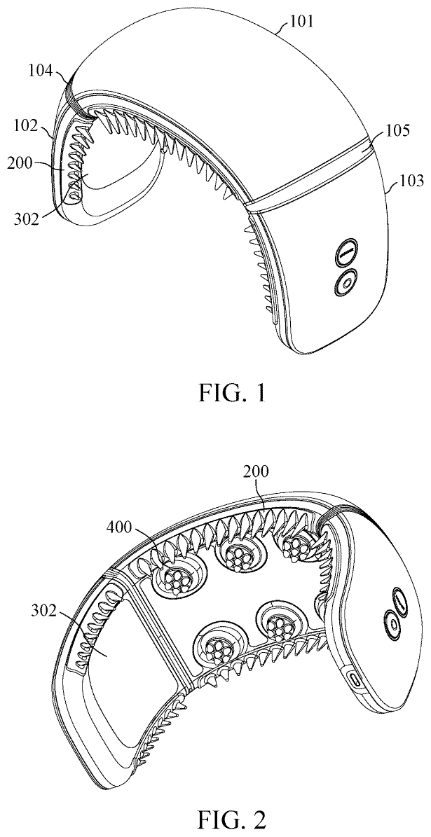

Referring to FIG. 1 and FIG. 2, a headband device for stimulating hair growth comprises a headband body, a comb tooth piece 200, a one or more stimulation elements, a massage head 400, and a driving assembly. The comb tooth piece 200 is detachably attached to the inner side surface of the headband body. The one or more stimulation elements is selected from a group consisting of a Light Emitting assembly, lasers, heating elements, cooling elements, vibration elements, electrodes, micro-current element and combinations thereof. The one or more stimulation elements when a light-emitting assembly comprises a light-emitting component mounted on the headband body and is used to emit light to the inside of the headband body. The massage head 400 can be rotated to connect to the inner surface of the headband body. The driving assembly is arranged in the headband body, and the power take-off end of the drive assembly is connected with the massage head 400.

The headband device of the present invention has the comb tooth piece 200 detachably connected with the headband body. The comb tooth piece 200 of different models can be selected according to different people, and the comb tooth piece 200 is easily dismantled to facilitate easy cleaning of the comb tooth piece 200. The detachable comb tooth piece 200 also improves the comfort and safety of the user wearing the headband device. The light-emitting component emits light on the scalp to effectively promote hair growth and maintenance. The driving assembly drives the massage head 400 to massage the scalp, which further enhances the blood circulation of the scalp, and provides more adequate nutrition for the hair, to further improves the effect of hair growth.

Referring to FIG. 1, the headband body comprises a main body portion 101, a first clamping portion 102 and a second clamping portion 103. One end of the first clamping portion 102 is connected with the first end of the main body portion 101 and one end of the second clamping portion 103 is connected with the second end of the main body portion 101.

In this embodiment, the first clamping portion 102 and the second clamping portion 103 are arranged to conform to ergonomics, and the wearing of the headband can be more convenient, and the comfort of use is improved.

Referring to FIG. 1, the headband body further comprises a first elastic connecting portion 104 and a second elastic connecting portion 105. One end of the first elastic connection portion 104 is connected with the first clamping portion 102, and the other end of the first elastic connecting portion 104 is connected with the main body portion 101. One end of the second elastic connection portion 105 is connected with the second clamping portion 103, and the other end of the second elastic connecting portion 105 is connected with the main body portion 101.

In an embodiment, the first elastic connecting portion 104 and the second elastic connecting portion 105 facilitate the adjustment of the angle of opening of the headband body, so that the user of different head sizes can be conveniently adapted for wearing. During the wearing process, the first elastic connecting portion 104 and the second elastic connecting portion 105 can respectively make the first clamping portion 102 and the second clamping portion 103 produce a clamping force to the user's head so that the wearing of the hairband body is more stable and not easy to fall off.

In an embodiment of the present application, the headband device comprises a plurality of comb tooth pieces 200, and the plurality of comb tooth pieces 200 are arranged on the inner edges of the main body portion 101, the first clamping portion 102, and the second clamping portion 103.

In an embodiment, the length of a single comb tooth piece 200 can be reduced by arranging a plurality of comb tooth pieces 200, so that the processing and production of the comb tooth pieces 200 is more convenient, and the production cost is reduced. FIG. 4 shows a plurality of comb teeth 202 arranged on the comb tooth piece 200.

In an embodiment, the comb tooth piece 200 not only supports the wearing of the headband firmly but is also used to comb the hair. The comb tooth piece 200 is made of soft plastic, which not only enhances the user's comfort during use, but also brings more practical advantages. First of all, the soft rubber comb 200 has better elasticity, which allows the comb to touch the scalp more gently when combing the hair, reducing discomfort while combing. Especially for users with sensitive scalps, this design is undoubtedly a big boon. Secondly, the soft rubber material also has a certain antistatic function. During the dry season, hair is prone to static electricity, which makes it sticky and difficult to comb. In addition, the use of soft rubber comb tooth piece 200 can reduce the generation of static electricity to a certain extent, so that the hair can maintain a natural and smooth state. In addition, the soft rubber comb 200 has good durability. Compared to combs made of hard plastic or metal, soft rubber materials are less prone to damage and retain good performance and appearance even after long periods of use.

In an embodiment of the present invention, the comb tooth piece 200 are hollow and provide a passage for dispensing a medicament or a lotion for hair growth. The medicament or lotion can be stored in the main body portion 101 or in the first clamping portion 102 or the second clamping portion 103.

In an embodiment of the present invention, the headband device further comprises a first magnetic piece and a second magnetic piece. The first magnetic piece is installed on the headband body. The second magnetic piece is arranged on the comb tooth pieces 200.

The first magnetic piece and the second magnetic piece binds with each other to position the comb tooth piece 200 on the headband body.

Through the magnetic connection of the first magnetic piece and the second magnetic piece, the detachable connection between the comb tooth piece 200 and the headband body is realized, and the comb tooth piece 200 can be detached conveniently for cleaning and replacing the comb tooth piece 200, thereby improving the user's convenience and life of the product.

In an embodiment of the present invention, the main body portion 101 is a clamping portion and the headband device comprises two or more clamping portion. At least one of the clamping portion has one or more comb tooth piece 200 configured to detachably connect with the clamping portion, and at least one stimulation element on the inner surface of the clamping portion. The clamping portion further comprises one or massage head on the inner surface of the clamping portion and a driving assembly connected to the one or more massage head. The driving assembly is configured to rotate the massage head in clockwise or anticlockwise direction.

In an embodiment of the present invention, a controlling unit is used to control the driving assembly, medicament dispensing, the massage head and one or more stimulation elements. The controlling unit can be positioned at the main body portion 101, the first clamping portion 102 or at the second clamping portion 103. The controlling unit comprise a controller, power button and one or more button to regulate the functioning or massage head, medicament dispensing or one or more stimulation elements. The controlling unit is configured to control the operation of massage head, the stimulation element in one clamping portion independently of the same components in other clamping portion.

In an embodiment of the present invention, the device is configured to connect with an external communication device over a communication interface. The controlling unit includes a processor, a memory unit and a communication interface. The communication with the external communication device is routed through the communication interface. The controlling unit is configured to connect with the external communication device and receives an input. The input may correspond to activating the stimulation element in any of the clamping portion or in the main body portion, activating massage head in any of the clamping portion or the main body portion, switching between continuous and pulse mode of operation of the LEDs or modification of emission characteristics of the plurality of LEDs such as wavelength of the radiation. The external communication device may be a smartphone, a desktop computer, a tablet, a Personal Digital Assistant (PDA), a smartwatch or the like.

In another embodiment of the present application, as shown in FIG. 4, the comb tooth pieces 200 comprise a connecting plate 201 and a plurality of comb teeth 202 are arranged on the connecting plate 201. The comb teeth 202 are arranged along the length direction of the connecting plate 201. The inner side of the headband body is provided with one or more strip grooves positioned at two ends of the stimulation element along the width direction. The connecting plate 201 is clamped into the one or more strip grooves. Through the clamping of connecting plate 201 and strip groove, the detachable connection of comb tooth piece 200 and headband body can be conveniently realized, and the comb tooth pieces 200 can be easily cleaned and replaced.

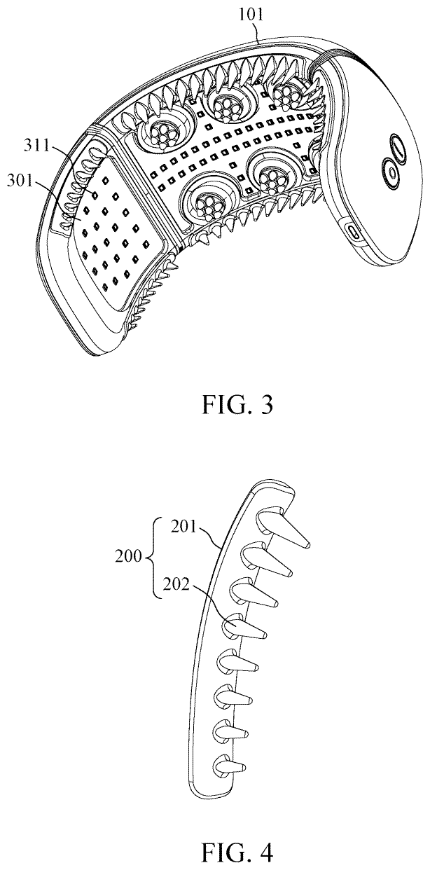

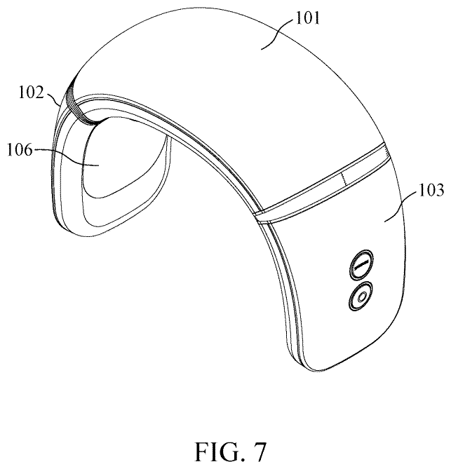

In an embodiment of the present application, the one or more stimulation element is a light-emitting assembly. Referring to FIG. 3, the light-emitting assembly comprises a light source 301 and a light-transmitting plate 302. The light source 301 is installed in the headband body. Referring to FIG. 7, the inner side surface of the headband body is provided with an opening 106, the light-transmitting plate 302 is connected with the headband body at the opening 106, and the light emitted by the light source 301 can be emitted through the light-transmitting plate 302.

In an embodiment, the light emitted by the light source 301 can be emitted through the light-transmitting plate 302 and directly irradiated on the user's scalp, thereby achieving the effect of promoting hair growth. At the same time, the design of the light-transmitting plate 302 can also ensure the uniformity and safety of light irradiation, and avoid unnecessary harm to users.

Referring to FIG. 3, the light source 301 comprises a plurality of LED lamp beads 311. The light emitted by the LED lamp beads 311 can be a laser or a non-laser red light, and the specific wavelength light emitted by these LED lamp beads 311 (for example: the wavelength is 655±5 nm) acts on the scalp, stimulates hair follicle cells, and promotes hair growth. The LED lamps beads 311 are plurality in number and are evenly distributed, ensuring that every inch of the scalp is fully illuminated. During use, users can adjust the brightness and irradiation time of the LED lamp bead 311 according to their personal needs. The higher the brightness and the longer the exposure time, the more significant the effect of phototherapy.

Referring to FIG. 6, the driving assembly comprises a driving member 501, an input gear, an output gear 504 and a transmission shaft 505. The input gear is connected with the output end 511 of the driving member 501. The output gear 504 is meshed with the input gear. The transmission shaft 505 is rotatably connected with the headband body, and the output gear 504 and the massage teeth 401 comb are arranged on the transmission shaft 505.

The driving member 501 provides power and transmits power to the output gear 504 through the input gear, and then drives the transmission shaft 505 and the massage head 400 to rotate. This design makes the rotation of the massage head 400 more stable and reliable, and it is also convenient for users to adjust the speed and strength of the massage head 400 to meet different use case scenario.

In an embodiment of the present application, the output end 511 is a worm, and the input gear comprises a worm gear 502 and a transmission gear 503 arranged axially. The worm is meshed with the worm gear 502, and the transmission gear 503 is meshed with the output gear 504.

The output end 511 of the driving member 501 adopts a worm, and the input gear comprises a coaxial worm gear 502 and a transmission gear 503, which can change the transmission direction of the output power of the driving member 501. This can further compress the space occupied by the driving assembly and is conducive to the miniaturization design of the headband.

In an embodiment of the present application, the headband device comprises a plurality of massage head 400, and each of the massage head 400 has a corresponding output gear 504 and transmission shafts 505.

The plurality of massage heads 400 can produce a massage effect when turning, which further promotes scalp blood circulation and hair growth. At the same time, the design of multiple massage head 400 also increases the massage area and strength, and improves the use effect.

In an embodiment of the present invention, the plurality of massage heads are arranged in two or more rows. The driving assembly rotates the massage head in one or more rows in clockwise direction and others rows in anticlockwise direction.

The output gear 504 is connected with a massage head 400 through a transmission shaft 505, and two adjacent output gears 504 can be meshed with each other, or meshed through an auxiliary gear, so that a single driving member 501 can drive a plurality of massage heads 400 to rotate simultaneously. The driving member 501 can adopt a double output motor, that is, the motor has two output ends 511, and each output end 511 adopts a worm. By adopting dual output motors, more massage heads 400 can be indirectly driven to rotate.

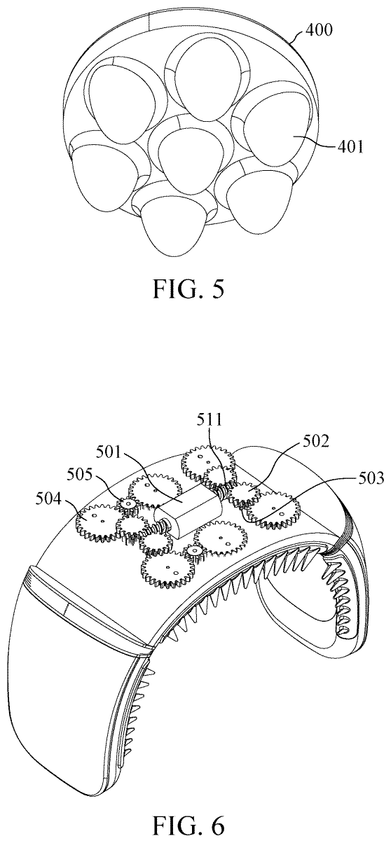

In an embodiment of the present application, a plurality of massage teeth 401 are arranged on the massage head 400. Referring to FIG. 1 and FIG. 5, a plurality of massage teeth 401 are arranged on the massage head 400, and when the massage head 400 is rotated, the fingering massage of a person can be simulated. The top of each massage teeth 401 is rounded to reduce irritation to the skin during the massage while increasing comfort. In consideration of direct contact with the skin, the massage teeth 401 is made of high-grade silicone, which is not only soft, but also has excellent durability and antibacterial properties. The massage tooth effectively transmits the vibrations of the massage head 400 to the deeper layers of the skin, bringing a deeper massage experience.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

1. A device for stimulating hair growth, the device comprising:
a main body portion;
one or more comb tooth piece configured to detachably connect with an inner surface of the main body portion;
at least one stimulation element on the inner surface of the main body portion;
one or more massage head on the inner surface of the main body portion; and
a driving assembly connected to the one or more massage head, the driving assembly is configured to rotate the massage head.

2. The device of claim 1, wherein the device comprises:
a first clamping portion, a first end of the first clamping portion is connected with a first end of the main body portion; and
a second clamping portion, a first end of the second clamping portion is connected with a second end of the main body portion.

3. The device of claim 2, wherein the device further comprises:
a first elastic connecting portion, a first end of the first elastic connecting portion is connected with the first clamping portion, and a second end of the first elastic connecting portion is connected with the main body portion; and
a second elastic connecting portion, a first end of the second elastic connecting portion is connected with the second clamping portion, and a second end of the second elastic connecting portion is connected with the main body portion.

4. The device of claim 2, wherein the one or more comb tooth piece are arranged on an inner edge of the main body portion, the first clamping portion and the second clamping portion.

5. The device of claim 1, wherein the one or more comb tooth piece comprises a connecting plate, the connecting plate has a plurality of comb teeth arranged along the connecting plate.

6. The device of claim 5, wherein the inner surface of the device comprises a strip-shaped grooves, and the connecting plate is clamped into the strip-shaped grooves.

7. The device of claim 1, wherein at least one stimulation element is selected from a group consisting of Light Emitting assembly, lasers, heating elements, cooling elements, vibration elements, electrodes, micro-current element and combinations thereof.

8. The device of claim 7, wherein the light emitting assembly comprises:
a light source in the device; and
a light transmission plate, the inner surface of the device is provided with an opening, the light transmission plate is connected with the main body portion at the opening, and light emitted by the light source is emitted through the light transmission plate.

9. The device of claim 1, wherein the driving assembly comprises:
a driving member;
an input gear connected with an output end of the driving member;
an output gear connected with the input gear; and
a transmission shaft rotatably connected with the main body portion, and the output gear and the one or more massage head are connected to the transmission shaft.

10. The device of claim 9, wherein the device comprises a plurality of massage head and each of the plurality of massage head is connected to the driving assembly.

11. The device of claim 1, wherein the device has a first magnetic piece and the one or more comb tooth piece has a second magnetic piece that detachably attached to the first magnetic piece.

12. A device for stimulating hair growth, the device comprising:
two or more clamping portion, wherein at least one of the two or more clamping portion comprises:
one or more comb tooth piece configured to detachably connect with the clamping portion;
at least one stimulation element on an inner surface of the clamping portion;
one or more massage head on the inner surface of the clamping portion; and
a driving assembly connected to the one or more massage head, the driving assembly is configured to rotate the massage head.

13. The device of claim 12, wherein the driving assembly rotates the one or more massage head in clockwise or anticlockwise direction.

14. The device of claim 12, wherein the one or more massage head comprises a first row of a plurality of massage head and a second row of plurality of massage head.

15. The device of claim 14, wherein the driving assembly rotates the first row of a plurality of massage head in clockwise direction and the second row of plurality of massage head in anticlockwise direction.

16. The device of claim 12, wherein the two or more clamping portion has a first magnetic piece and the one or more comb tooth piece has a second magnetic piece that detachably attached to the first magnetic piece.

17. The device of claim 12 further comprises a controlling unit positioned at two or more clamping portion or at one of the two or more clamping portion, the controlling unit is configured to independently control functioning of the two or more clamping portion.

18. The device of claim 12 wherein the two or more clamping portion are connected with each other through an elastic connecting portion.

19. The device of claim 12, wherein the one or more comb tooth piece are hollow and are used for dispensing a medicament or lotion.

20. A device for stimulating hair growth, the device comprising:
a main body portion;
one or more comb tooth piece configured to detachably connect with an inner surface of the main body portion;
at least one stimulation element on the inner surface of the main body portion;
one or more massage head on the inner surface of the main body portion;
a driving assembly connected to the one or more massage head, the driving assembly is configured to rotate the massage head; and
wherein the device has a first magnetic piece and the one or more comb tooth piece has a second magnetic piece that detachably attached to the first magnetic piece.
